(19) United States
(12) Patent Application Publication
(10) Pub. No.: US 2007/0064007 A1
(43) Pub. Date: Mar. 22, 2007

(54) Image display system and method

(76) Inventors: Winthrop D. Childers, San Diego, CA (US); William J. Allen, Corvallis, OR (US)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(21) Appl. No.: 11/225,908

(22) Filed: Sep. 14, 2005

(51) Int. Cl. G09G 5/02

(52) U.S. Cl. 345/589; 345/643

(57) ABSTRACT

Disclosed are embodiments of a system and method for processing an image. An image processing unit includes a processor unit and a control unit. The processor unit is configured to receive an incoming video signal. The control unit is configured to generate first control signals that define bit planes manifested on a spatial light modulator. The control unit is further configured to generate second control signals that define on and off states for a solid state light source. The first control signals impart a reset motion sequence for mirror elements of the spatial light modulator. The second control signals maintain the solid state light source in the off state during at least part of the reset motion.

### BACKGROUND

Various techniques for displaying images exist. One such approach is accomplished with the use of digital image projectors or digital light processing (DLP)-based projectors that utilizes data and signal driven DMDs (digital mirror devices). Typically, it is preferable to enable the generation of a large number of colors on such projectors, sometimes referred to as “bit depth”. One issue with enabling a high degree of bit depth is the data rate and mirror transition bottlenecks with DMDS. These bottlenecks often cause the designer to trade off resolution, brightness, and/or visual artifacts against the need for precise color generation.

### SUMMARY

Exemplary embodiments of the present invention include a system and method for processing an image. An image processing unit includes a processor unit and a control unit. The processor unit is configured to receive an incoming video signal. The control unit is configured to generate first control signals that define bit planes manifested on a spatial light modulator. The control unit is further configured to generate second control signals that define on and off states for a solid state light source. The first control signals impart a reset motion sequence for mirror elements of the spatial light modulator. The second control signals maintain the solid state light source in the off state during at least part of the reset motion.

### BRIEF DESCRIPTION OF THE DRAWINGS

FIG. 1 illustrates a schematic diagram of a system for displaying images according to an embodiment of the present invention.

FIG. 2 is timing diagram illustrating a portion of a frame period including a sequence of bit planes according to embodiments of the present invention.

FIGS. 3A-3C are timing diagrams illustrating exemplary least significant bit planes according to embodiments of the present invention.

FIGS. 4A-4C are timing diagrams illustrating exemplary least significant bit planes according to embodiments of the present invention.

FIGS. 5A-5C are timing diagrams illustrating exemplary least significant bit planes according to embodiments of the present invention.

FIG. 6 illustrates an exemplary time period for an image display system in accordance with various embodiments of the present invention.

FIGS. 7A-7D are exemplary time periods illustrating bit plane duration for a series of bit planes in accordance with an embodiment of the present invention.

FIGS. 8A-8C are exemplary time periods illustrating a data loading sequence in accordance with an embodiment of the present invention.

### DETAILED DESCRIPTION

In the following Detailed Description, reference is made to the accompanying drawings, which form a part hereof, and in which is shown by way of illustration specific embodiments in which the invention can be practiced. It is to be understood that other embodiments can be utilized and structural or logical changes can be made without departing from the scope of the present invention. The following Detailed Description, therefore, is not to be taken in a limiting sense, and the scope of the present invention is defined by the appended claims.

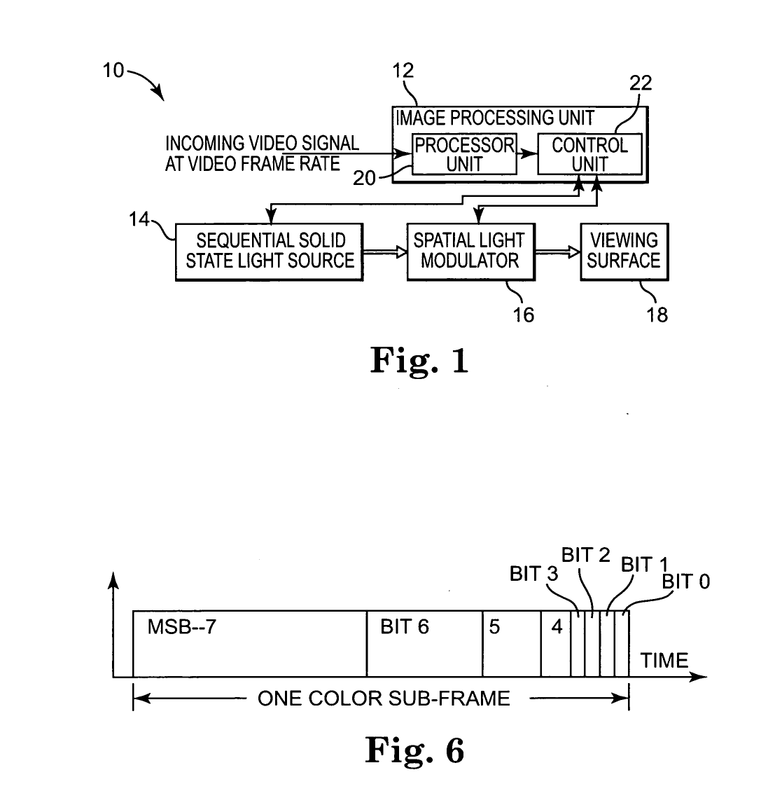

FIG. 1 illustrates image display system 10 in accordance with one embodiment of the present invention. In one example, image display system 10, includes image processing unit 12, sequential solid state light source 14, spatial light modulator 16 and viewing surface 18. In one example, image display system 10 is a digital projector that is used to project an image. Image processing unit 12 receives an incoming video signal. The video signal has an associated video frame rate. Image processing unit 12 processes the video signal and then controls the sequential solid state light source 14 and spatial light modulator 16 in order to project the incoming video signal as an image on viewing surface 18.

In one embodiment, image processing unit 12 includes processor unit 20 and control unit 22. Processor unit 20 is configured to receive the incoming video signal and to generate image characteristic information indicative of the video signal. Control unit 22 is then configured to receive the image characteristic information indicative of the video signal and to generate control signals used to control solid state light source 14 and spatial light modulator 16. In this way, rather than being optimized for high color saturation or high brightness, image display system 10 in accordance with one embodiment of the invention provides an analysis of the characteristics of the video signal in order to provide optimized image frame and/or bit plane generation according to the characteristics of the video signal.

In one embodiment, sequential solid state light source 14 is a plurality of solid state light emitting diodes (LEDs). For example, in one case, sequential solid state light source 14 includes red LED(s), green LED(s), and blue LED(s). It can be appreciated that alternative and/or additional solid state light sources can be used generating colors such as white, cyan, yellow, magenta, among others. The solid state light source is optically configured to illuminate a pixel array formed in a surface of spatial light modulator 16.

In one embodiment, spatial light modulator 16 is a digital micro-mirror device (DMD). A DMD has an array of micro-mechanical display elements, each having a tiny mirror that is individually addressable with an electronic signal. Depending on the state of its addressing signal, each mirror tilts so that it either does or does not couple light to an image plane of viewing surface 18. Each of the mirrors is referred to as a “pixel element,” and the image each pixel element generates upon the viewing surface 18 can be referred to as a “pixel.” Generally, displaying pixel data is accomplished in part by loading memory cells connected to the pixel elements. Each memory cell receives one bit of data representing an on or off state of a pixel element. The image processing unit 12 is configured to maintain the pixel elements in their on or off states for a controlled duration.

The present invention can be applicable to other spatial light modulators 16 that are rapidly switchable between on and off states to define images on a viewing surface. Examples of other spatial light modulator technologies include LCOS (liquid crystal on silicon) and linear arrays of deflectable beams.

In one embodiment, the image processing unit 12 is configured to receive an incoming video signal and to convert that signal into a sequence of image frames. Each image frame defines primary color values for each pixel to be defined upon viewing surface 18. In one example, the color values would represent the intensity of red, green, and blue components of light to be displayed for each pixel displayed on viewing surface 18.

The image processing unit 12 is further configured to convert each image frame into a plurality of bit planes. Each of the plurality of bit planes defines an associated primary color and bit plane time period having a bit plane time duration. Within a bit plane time period, each pixel element of modulator 16 is either in an on or off state. Each bit plane time period further defines one or more time slices, each having a time slice time period. When a bit plane time period is divided into more than one time slice, the time slices are temporally separated within a frame period. To define the primary color associated with the bit plane, the image processing unit 12 is configured to operate the solid state light source 14 to illuminate the spatial light modulator 16 with light having a spectral distribution that defines the primary color during the bit plane time period.

During the bit plane time period, an array of pixels corresponding to the array of pixel elements is cast upon viewing surface 18. For the array of pixels, there is a pixel having the primary color corresponding to each pixel element that is in the on state. There is a missing or black pixel for each pixel element that is in the off state.

In one embodiment, control unit 22 sends control signals to the solid state light source defining a sequence of states for the solid state light source. Each of the sequence of states defines an average intensity and a primary color of light that the solid state light source 14 provides to the array of pixel elements on spatial light modulator 16 during each bit plane time period.

In one embodiment, each of the sequences of states for the solid state light source 14 corresponds to one of the sequences of time slices that are each manifested on spatial light modulator 16, one time slice after another. During the sequence of time slices, the average intensity (averaged over the time slice time period) changes from one time slice to the next for one or more sequential pairs of time slices. During the sequence of time slices, a selection of a primary color of light that the solid state light source 14 provides changes from one time slice to the next for one or more sequential pairs of time slices.

In one embodiment, the control unit 22 sends control signals to the solid state light source 14 that defines a sequence of light pulses emitted by the solid state light source 14. A light pulse is defined as the light source 14 turning on for a brief duration and then off. A light pulse is characterized by an average intensity level, a primary color emitted, and a duration.

In one embodiment, each light pulse has a time duration that falls within one of the time slices. Stated another way, the solid state light source 14 turns on at the beginning or within the time slice time period and turns off at the end or within the time slice period so that the duration during which the solid state light source is on (the light pulse duration) falls within the time slice time period. For some time slices, there can be more than one light pulse emitted during each time slice time period.

To quantify the generation of bit planes, consider an example wherein the image frames are generated at 60 frames per second such that each frame lasts for approximately 16.67 milliseconds. To generate 24 bit color or 8 bits per primary color, a minimum of 8 bit planes need to be defined per primary color. The bit planes typically have time durations that vary in a binary manner, from the least significant bit (“LSB”) to the most significant bit (MSB).

Based upon this, it would be expected that the LSB for a given primary color would have a time duration of about one third of about 1/256^{th} of a frame period, or about 22 microseconds. This can result in an operational bottleneck due to the immense data rate and mirror frequency requirements for the system to position the mirrors for a bit plane. In one embodiment, this can be mitigated by modulating the light source within bit planes to extend the minimum duration requirement for bit planes.

Having a time-contiguous MSB can result in visual artifacts frame to frame. Therefore, dividing up the MSB over the frame period can be optimal. Stated another way, the most significant bit time period is divided up into non-contiguous or temporally separated time slices. For each most significant bit plane, the time slices are distributed or temporally spaced apart during the frame period.

An exemplary set of bit planes for a single primary color that takes the aforementioned factors into account is depicted in the following table:

| Bit | | Duration/Time | | |
|---|---|---|---|---|
| Plane | Weighting | Slice | No. of Slices | Avg. Intensity |
| 0 | 1 | 1 | 1 | 1 |
| 1 | 2 | 1 | 1 | 2 |
| 2 | 4 | 1 | 1 | 4 |
| 3 | 8 | 1 | 1 | 8 |
| 4 | 16 | 2 | 1 | 8 |
| 5 | 32 | 2 | 2 | 8 |
| 6 | 64 | 2 | 4 | 8 |
| 7 | 128 | 2 | 8 | 8 |

In this example, the entire frame period is divided up onto 19 time slices for each of red, green, and blue, or a total of 57 time slices. The least significant bit plane is generated in one time slice that is about 163 microseconds long. This is made possible by the variation in the average intensity adjustments for bit planes 0 to 3. In the example depicted in the table above, the most significant bit plane (bit 7) time period is divided up into 8 separate time slices that can be temporally separated over the frame period.

The following defines terms used in the table.

Weighting: The weighting depicted above is binary, but this need not be the case. The weighting factor is proportional to the per pixel contribution to the average intensity during a frame period when that pixel is turned ON.

Duration/Time Slice: The time duration of each time slice. For the case where each of three primary colors are handled equally and for a 60 hertz frame rate, the shortest duration time slice (for bit planes 0-3) would have a duration of about 163 microseconds.

No. of Slices: How many time slices are required to provide that significance of bit. Stated another way, this is the number of temporally spaced time slices utilized to provide the bit plane time period.

Avg. Intensity: Average intensity of light received by the DMD from the solid state light source during each time slice for that bit. This intensity level can be achieved by varying the actual intensity of the light source or by varying the duty cycle (percentage of the duration of the bit plane for which the light source is ON) during the bit plane time period.

To avoid various visual artifacts, it is best to temporally separate the most significant bits for each primary color. Keeping this in mind, the following is an exemplary temporal sequence of time slices during a frame period based on the earlier table:

7R, 7G, 7B, 6R, 6G, 6B, 7R, 7G, 7B, 4R, 4G, 4B, 7R, 7 G, 7B, 3R, 3G, 3B, 2R, 2G, 2B, 1R, 1G, 1B, 0R, 0G, 0B, 6R, 6G, 6B, 7R, 7G, 7B, 5R, 5G, 5B, 7R, 7G, 7B, 6R, 6G, 6B, 7R, 7G, 7B, 5R, 5G, 5B, 7R, 7G, 7B, 6R, 6G, 6B7R, 7G, 7B

In this example, 6R is indicative of one time slice of bit 6 for red, 3B means bit 3 for blue, etc. As discussed earlier, bits 7, 6, and 5 for each primary color are divided up into 8, 4, and 2 temporally separated time slices respectively. In this way, the image processing unit 12 generates first control signals to define the bit planes such as those discussed above that are manifested upon spatial light modulator 16.

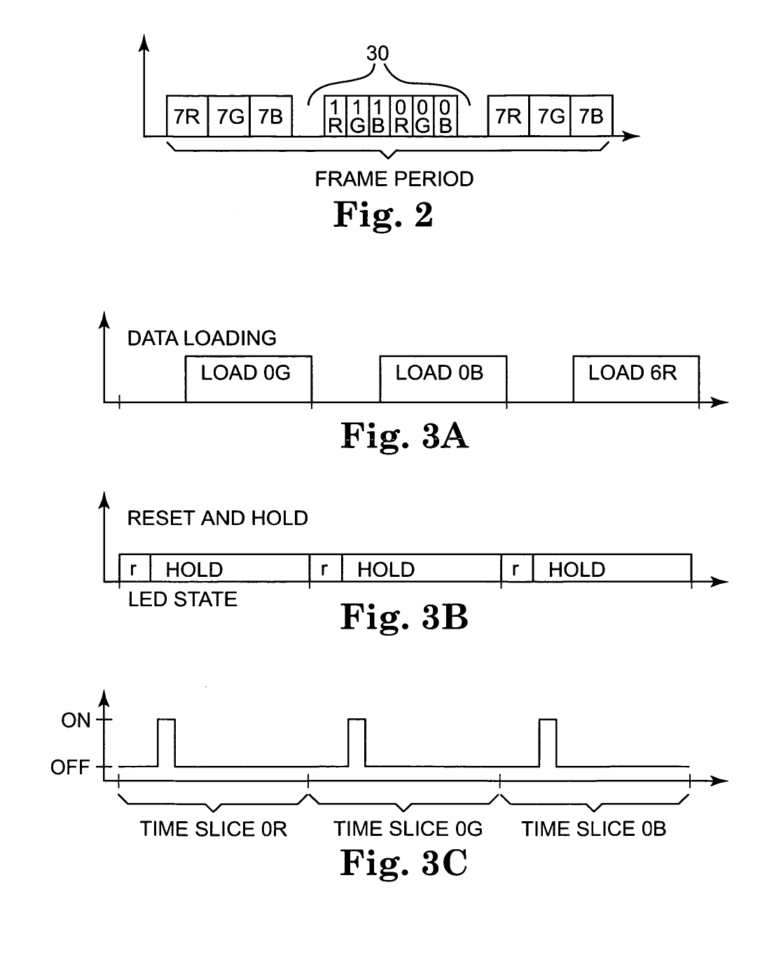

A timing diagram illustrating part of the time slices from this sequence is depicted in FIG. 2. The timing diagram of FIG. 2 only depicts 12 of the 57 time slices in the sequence above with time slices in gaps 30 left out of the timing diagram for simplicity.

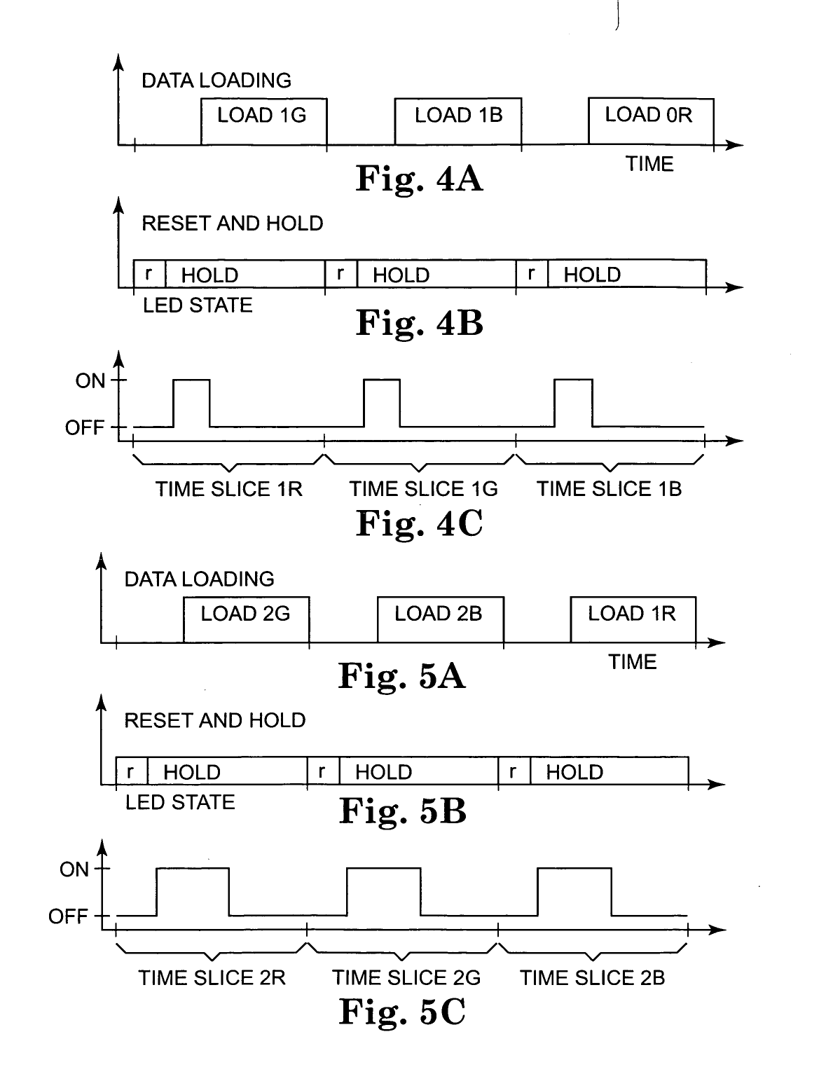

FIGS. 3-5 depict timing diagrams for the 3 least significant bit planes, including bit plane 0, 1, and 2. The least significant bit planes are not divided up temporally into time slices; therefore bit plane 0 can be referred to as time slice 0 and vice versa. For each bit plane depicted, the timing diagram illustrates (A) data loading to the DMD, (B) reset and hold signals, and (C) LED operation. FIGS. 3A, 4A, and 5A depict timing for data loading for bit planes 0, 1, and 2, respectively. FIGS. 3B, 4B, and 5B depict the application of reset (r) and hold signals for bit planes 0, 1, and 2, respectively. FIGS. 3C, 4C, and 5C depict the operating of the LEDS for bit planes 0, 1, and 2, respectively.

For each time slice (or bit plane), data is loaded in the prior time slice. For example, referring to FIG. 3A, data for time slice 0G (bit 0 for green) is loaded while the time slice 0R (bit 0 for red) is being manifested on the light modulator 16. The least significant bit time slices each have a long enough time duration to allow the pixel data for the entire pixel array to be transferred from image processing unit 12 to spatial light modulator 16 during each of the least significant bit time slice periods.

Each time slice generally contains a reset sequence starting at the beginning of the time slice and a hold sequence ending at the end of the time slice. At the start of a time slice, the image processing unit sends a reset pulse (r) to the pixel elements. This allows the pixel elements to assume a position consistent with the data received during the previous time slice. For example, referring to FIGS. 3A-3C, during the reset pulse (r) received during time slice 0G, the pixel elements align themselves pursuant to the data (0G) received and loaded during time slice 0R.

Once the pixel elements have had time to reset, a hold signal is applied. This hold signal places the pixel elements into their proper ON or OFF state for the time slice (according to bit plane data). The hold signal is applied until the end of time slice.

The LED light source is off at the beginning of each time slice. The LED lights source turns on at the beginning of or during the hold signal. The LED light source turns off at the end of or during the hold signal. Thus, the LED light source generates a pulse that is temporally contained within the duration of the hold signal.

FIGS. 3C, 4C, and 5C depict pulse width modulation of the LED light source to define bit planes 0, 1, and 2 respectively. FIGS. 3-5 depict a single LED pulse defining the contribution of each bit plane or time slice, but the pulses can just as easily be further subdivided within each time slice. The LED light source may be able to define pulse widths as narrow as approximately 1 microsecond. In this way, what is depicted in the figures as a single pulse, could alternatively be multiple pulses.

In one embodiment, image processing unit 12 is also configured to analyze the incoming video signal and in response to generate image characteristic information indicative of the incoming video signal. Based upon image characteristic information, the image processing unit sends second control signals that define an illumination characteristic of light received by the spatial light modulator 16 from solid state light source 14 for each bit plane. In one embodiment, the illumination characteristic of light defines the primary color and/or the average intensity of light received by the light modulator 16 during the bit plane time period defined by each bit plane.

The image processing unit 12 analyzes the incoming frames based on the characteristics of the frames in order to define the image characteristic information indicative of the video signal. In one embodiment, the image characteristic information is indicative of an illumination intensity characteristic of at least one of the incoming frames. In one case, the illumination intensity characteristic is an average luminance of light during a frame period, which can be measured in a variety of ways.

In one embodiment, image processing unit 12 analyzes incoming image frames based on a multi-frame aspect, and in another, on a frame-by-frame aspect. Alternatively, image processing unit 12 receives a select signal from the user of the projector indicative of an operating preference and produces image characteristic information from this user selection. For example, in one case the user increases brightness at the expense of color gamut in order to achieve a desired output. In still other embodiments, image characteristic information is produced from a combination of analysis of the incoming frames based on the characteristics and upon a user selection.

Once image processing unit 12 generates the image characteristic information, either from analyzing the incoming frames, from user selection, or a combination thereof, image processing unit 12 then generates bit plane control signals for the spatial light modulator 12 and the solid state light source 14 based upon the image characteristic information. The bit plane control signals include first control signals imparted to the spatial light modulator 16 and second control signals imparted to the solid state light source. The first set of control signals define a plurality of bit planes to be manifested upon the spatial light modulator. For each bit plane, the first set of control signals defines which pixel elements are in an ON or OFF state during the bit plane as well as the bit plane duration. The second set of control signals define a primary color (spectral distribution) and average intensity of light received by the spatial light modulator for each bit plane as discussed by the following examples.

In a first example, the second set of control signals defines an average intensity of light received by the spatial light modulator during a frame period. In this example, the image characteristic information may be indicative of the brightness of scene to be displayed by system 10. The image processing unit may then adjust the average intensity or duty cycle of the solid state light source during each image frame or a sequence of image frames.

In a second example, the second set of control signals defines an average intensity of light received by spatial light modulator 16 within each bit plane. In this second example, the solid state light source is turned off during pixel element transitions and is modulated rapidly enough to only be on during each bit plane.

In a third example, the image processing unit 12 defines what primary colors are utilized during a frame period. For example, additional primary colors beyond red, green, and blue can be utilized. This may be important if a scene to be displayed is dominated by a particular color such as yellow, cyan, or white. In such a case, the signals define yellow, cyan, and/or white bit planes or time slices that may be interleaved with the RGB (red, green, and blue) bit planes.

In a fourth example, the image processing unit 12 defines a portion or fraction of the frame period duration to be allocated for each primary color. For a scene that is dominated by red, for instance, the combined duration of the red bit planes may utilize more than one third of the duration of the frame period.

FIG. 6 illustrates an alternative timing diagram for a single color sub-frame for a 24 bit color system. The depicted color sub-frame is intended to illustrate a simplified embodiment of some aspects of the present invention. During the illustrated sub-frame, bit planes including MSB plane 7, bit plane 6, bit plane 5, bit plane 4, bit plane 3, bit plane 2, bit plane 1 and LSB plane 0 are illustrated. These bit planes are to be manifested upon spatial light modulator 16 and the control signals define which pixel elements are in an ON or OFF state during portions of each bit plane duration. In the illustrated example, each bit plane contributes one half of the apparent intensity of the next higher numbered bit plane. For example, bit plane 5 contributes one half of the apparent intensity of bit plane 6.

In the illustration, however, bits planes 0-3 are each of the same time duration. Consequently, in accordance with one embodiment of the invention, in order to ensure that each bit plane contributes one half of the apparent intensity of the next higher numbered bit plane for these four bit planes, solid state light source 14 is modulated during bits planes 0-3.

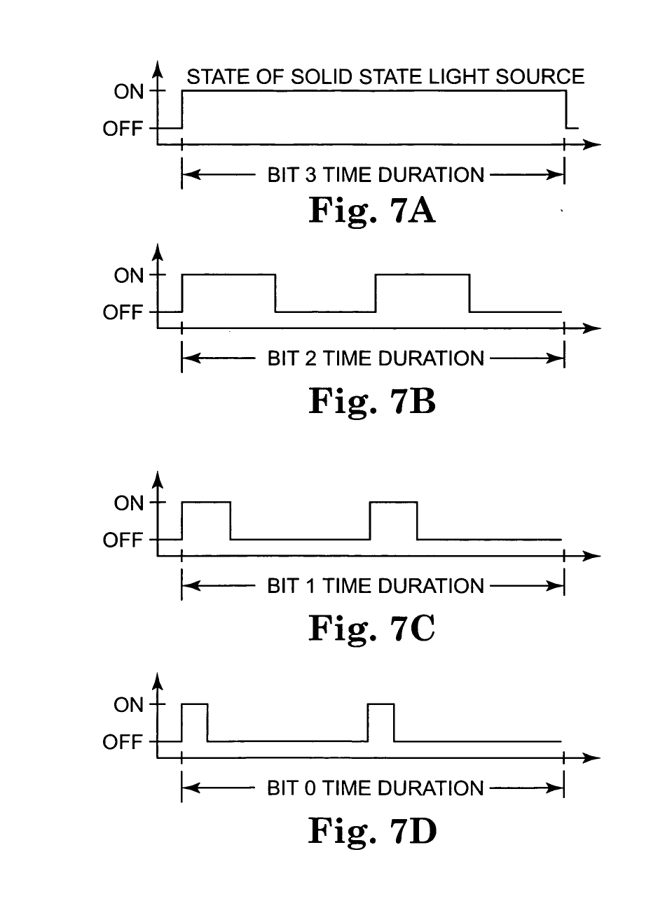

The state of the solid state light source 14 versus time during each of the last 4 significant bits is illustrated in the timing diagrams of FIGS. 7A-7D. FIG. 7A illustrates the fourth least significant bit plane (bit plane 3), where the solid state light source 14 is on for the entire bit plane duration. FIG. 7B illustrates the third least significant bit plane (bit plane 2), where the solid state light source 14 is on for one half of the bit plane duration. FIG. 7C illustrates the second least significant bit plane (bit plane 1), where the solid state light source 14 is on for one quarter of the bit plane duration. FIG. 7D illustrates the LSB plane (bit plane 0), where the solid state light source 14 is on for one eighth of the bit plane duration.

This “sub-modulation” of solid state light source 14 during these least significant bits planes 0-3 ensures that each bit plane still effectively contributes one half of the apparent intensity of the next higher numbered bit plane, while at the same time allowing certain bit planes (bit planes 0-3 in the illustration) to be of the same time duration at spatial light modulator 16.

In this way, limitations in switching speeds of spatial light modulator 16 can be overcome. Conventional micro-mirror based projector systems, such as the DLP-based systems, generate defined bit planes during which each pixel element of a light modulator is either on or off. The bit depth of such systems is partly dependent upon how fast the pixel elements can switch. When using a three color wheel at a 60 Hz (or sometimes faster) frame or sub-frame rate, the required mirror frequency is about 46 KHz or higher to achieve 24 bit color. This is difficult to accomplish due to limitations in switching speeds. Consequently, some systems obtain this color depth by the use of spatial dithering (with a checkerboard pattern) that may be temporally varied frame to frame. This can result in certain visual artifacts and/or resolution loss.

In one embodiment, image display system 10 provides full 24 bit (or higher) color without any compromise in resolution. For some bit planes, including the least significant bit planes in the illustration, the image processing unit 10 is configured to pulse width modulate the solid state light source 14 at a rate that is higher than rate of pulse width modulation of the spatial light modulator 16. Stated another way, the pulse width of the solid state light source 14 is shorter than the time duration of the least significant bits.

In a further embodiment, image display system 10 employs an optimized sequence in order to maximize brightness, bit depth, and contrast ratio for the image displayed on viewing surface 18. In one exemplary embodiment, solid state light source 14 is a LED light source and spatial light modulator 16 is a DMD array having a plurality of micro-mirrors. Before a bit plane can be manifested upon the micro-mirrors, they need to be released or reset to a flat state. After being reset, they are tilted slightly pursuant to the particular bit plane (that specifies either ON or OFF for each mirror element). From that state, a hold circuit clamps or fully tilts the mirrors for that bit plane.

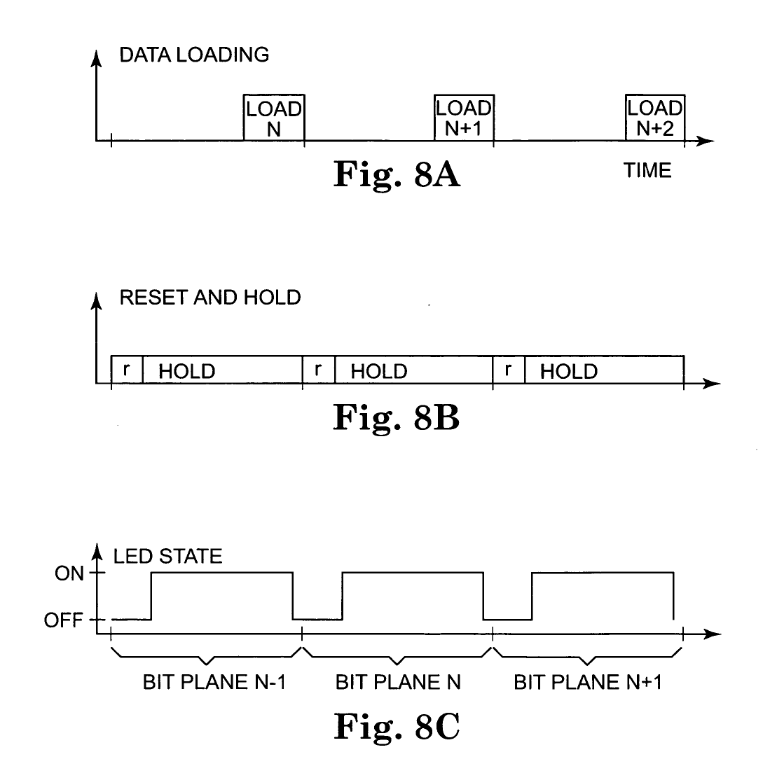

FIGS. 8A-8C are timing diagrams illustrating an exemplary optimized sequence for image display system 10. Image display system 10 utilizes the DMD array and the LED light source to optimize an operating sequence for each bit plane as follows: (1) The LED light source is initially OFF; (2) The bit plane data is loaded to the DMD prior to the bit plane time period; (3) The DMD array receives a reset signal at the start of the bit plane time period; (4) A HOLD signal is applied to the DMD until the end of the bit plane time period; (5) The LED light source is switched to the ON state at least once after HOLD signal is started and switched to the OFF state before the bit plane period is over.

Conventional DLP systems utilize a periodic color light source, such as a color wheel that modulates a light beam. The modulated light is cast upon a micro-mirror array of the DMD. The color wheel generates a complete sequence of color sub-frames during a frame period. With such a system, however, it is difficult to switch the mirrors fast enough to achieve a high bit depth, contrast ratio losses due to light reflected during mirror transitions, and “spoke losses” of light during transitions between primary colors.

With the above-described optimized sequence, image display system 10 can ensure that the LED light source is not on when the micro-mirrors of the DMD array are in transition to or from the tilted state, thereby avoiding light leakage. Furthermore, the speed at which the LED light source can be controlled is utilized to enable high bit depths, controlled such that blanking periods do not reduce brightness, and increases contrast ratio.

In another embodiment, the bit planes are further interleaved such that the primary color being displayed is varied many times during a frame period up to the number of bit planes minus one. In this way, “rainbow effect” artifacts of sequential color are avoided where the primary colors are interleaved.

Although specific embodiments have been illustrated and described herein, it will be appreciated by those of ordinary skill in the art that a variety of alternate and/or equivalent implementations can be substituted for the specific embodiments shown and described without departing from the scope of the present invention. This application is intended to cover any adaptations or variations of the specific embodiments discussed herein. Therefore, it is intended that this invention be limited only by the claims and the equivalents thereof.

What is claimed is:

1. An image processing unit comprising:
a processor unit configured to receive an incoming video signal; and
a control unit configured to generate first control signals that define bit planes from the video signal for a spatial light modulator and further configured to generate second control signals that define on and off states for a solid state light source;
wherein the first control signals impart a reset motion sequence for mirror elements of the spatial light modulator and wherein the second control signals maintain the solid state light source in the off state during at least part of the reset motion.

2. The image processing unit of claim 1, wherein the first control signal includes a reset signal imparting the reset motion sequence and a hold signal that follows the reset signal, and wherein the solid state light source is maintained in the off state before the hold signal and is placed in the on state during the hold signal.

3. The image processing unit of claim 1, wherein the spatial light modulator includes an array of pixel elements, wherein the first control signal imparts transitions of each of the array of pixel elements, and wherein the solid state light source is maintained in the off state during the transitions.

4. The image processing unit of claim 2, wherein the hold signal is applied for a hold period, and wherein the solid state light source is modulated during the hold period to define at least a least significant bit plane.

5. The image processing unit of claim 4, wherein the solid state light source is modulated during the hold period to define a plurality of least significant bit planes.

6. The image processing unit of claim 1, wherein the spatial light modulator includes an array of pixel elements, wherein each of the bit planes defines a bit plane time period and a binary state of each of the array of pixel elements, and wherein each binary state is either an on or an off pixel element state during the bit plane time period.

7. The image processor of claim 6, wherein each of the bit plane time periods includes one or more time slices, and wherein the second control signal defines a state of the solid state light source during each of the time slices.

8. The image processor of claim 7, wherein the second control signal defines a primary color selection of light illuminating the spatial light modulator during each of the time slices.

9. The image processor of claim 8, wherein the primary color selection changes for one or more pairs of time slices in a sequence.

10. The image processing unit of claim 1, wherein the second control signals defines a sequence of light pulses emitted by the solid state light source.

11. The image processing unit of claim 10, wherein each of the bit plane time periods includes one or more time slice time periods, and each of the sequence of light pulses falls within one of the time slice time periods.

12. The image processing unit of claim 11, wherein one or more time slice time periods each contains two or more light pulses.

13. An image processing unit comprising:
processor means for receiving an incoming video signal; and
control means for generating first control signals that define bit planes from the video signal for a spatial light modulator, each of the bit planes being manifested on the spatial light modulator during a bit plane time period, and for generating second control signals that define states for a solid state light source within each bit plane time period;
wherein the second control signals modulates the solid state light source during at least one of the bit planes to enable a least significant bit plane.

14. The image processing unit of claim 13, wherein at least some of the bit time periods are divided into time slices that are temporally separated during a bit plane time period.

15. The image processing unit of claim 13, wherein the second control signals modulate the solid state light source to define enough least significant bit planes to enable a complete transfer of data to the spatial light modulator during the least significant bit plane.

16. The image processing unit of claim 13, wherein the spatial light modulator includes an array of pixel elements, the first control signal defines a reset motion sequence for each of the pixel elements, the second control signals maintain the solid state light source in an off state during at least part of the reset motion sequence.

17. The image processing unit of claim 13, wherein the spatial light modulator includes an array of pixel elements, the first control signal defines a hold signal period for each of the pixel elements, the second control signal modulates the solid state light source during the hold signal period.

18. The image processing unit of claim 13, wherein spatial light modulator includes an array of pixel elements, the first control signal imparts transitions of each of the array of pixel elements, the solid state light source is maintained in the off state during the transitions.

19. An image processing unit comprising:
a processor unit configured to receive an incoming video signal; and
a control unit configured to generate first control signals that define bit planes each of which are manifested upon a spatial light modulator during one or more time slice time periods and further configured to generate second control signals that define a sequence of light pulses emitted by a solid state light source, each of the sequence of light pulses contained within one of the time slice time periods.

20. The image processing unit of claim 19, wherein the second control signals define two least significant bit planes by modulating the average of intensity of light received by the spatial light modulator during each of the two least significant bit planes.

21. The image processing unit of claim 19, wherein during each time slice time period the first control signals define a reset motion sequence followed by a hold period and wherein the second control signals define a light pulse that illuminates the spatial light modulator during the hold period.

22. The image processing unit of claim 21 wherein the second control signals maintain the solid state light source in an off state during the reset motion sequence.

23. An image display system comprising:
an image processing unit configured to receive an incoming video signal;
a sequential solid state light source coupled to the image processing unit; and
a spatial light modulator coupled to the sequential solid state light source and to the image processing unit;
wherein the image processing unit sends a first control signal to the spatial light modulator for defining bit planes from the video signal to be displayed by the spatial light modulator, wherein the image processing unit sends a second control signal that define on and off states for the solid state light source within each of the bit planes, wherein the second control signals impart a reset motion sequence for mirror elements of the spatial light modulator, and wherein the first control signals maintain the solid state light source in the off state during at least part of the reset motion.

24. The image processing unit of claim 23, wherein the second control signals define two least significant bit planes by modulating the average intensity of light received by the spatial light modulator during each of the two least significant bit planes.

25. A method of processing an image comprising:
receiving an incoming video signal;
generating first control signals from the video signal that define bit planes for a spatial light modulator;
manifesting each of the bit planes on the spatial light modulator during a bit plane time period;
generating second control signals from the video signal that define states for a solid state light source within each bit plane time period; and
modulating the solid state light source during at least one of the bit planes with the second control signals to enable a least significant bit plane.

26. The method of claim 25 further including dividing at least some of the bit time periods into time slices that are temporally separated during a bit plane time period.

27. The method of claim 25 further including modulating the solid state light source with the second control signals to define enough least significant bit planes to enable a complete transfer of data to the spatial light modulator during the least significant bit plane.

28. The method of claim 25 further including defining a reset motion sequence for each of an array of pixel elements of the spatial light modulator and maintaining the solid state light source in an off state during at least part of the reset motion sequence.

29. The method of claim 25 further including defining a hold signal period for each of an array of pixel elements of the spatial light modulator and modulating the solid state light source during the hold signal period.

30. The method of claim 25 further including imparting transitions of each of an array of pixel elements of the spatial light modulator and maintaining the solid state light source in the off state during the transitions.
